(19) United States
(12) Patent Application Publication
(10) Pub. No.: US 2024/0051083 A1
(43) Pub. Date: Feb. 15, 2024

(54) CYLINDRICAL STACK OF FIXTURE RING FOR SURFACE TREATMENT OF TURBINE VANES

(71) Applicant: Oerlikon Surface Solutions AG, Pfaeffikon, Pfaeffikon (CH)

(72) Inventors: Ruedi MEILER, Schiers (CH); Carmen JERG, Feldkirch (AT); Simon BELVÈZE, Limoges (FR)

(73) Assignee: Oerlikon Surface Solutions AG, Pfaeffikon, Pfaeffikon (CH)

(21) Appl. No.: 18/382,854

(22) Filed: Oct. 23, 2023

Related U.S. Application Data
(63) Continuation of application No. PCT/EP2022/060780, filed on Apr. 22, 2022.

(30) Foreign Application Priority Data
Apr. 23, 2021 (DE) 10 2021 002 146.0

(51) Int. Cl. B24B 41/06

(52) U.S. Cl. CPC B24B 41/06

(57) ABSTRACT

A segment of a fixture, the fixture being comprised of a number of such segments arranged to form a fixture ring, the segment comprising a carrier segment and a cap segment.

This nonprovisional application is a continuation of International Application No. PCT/EP2022/060780, which was filed on Apr. 22, 2022, and which claims priority to German Patent Application No. 10 2021 002 146.0, which was filed in Germany on Apr. 23, 2021, and which are both herein incorporated by reference.

### BACKGROUND OF THE INVENTION

### Field of the Invention

The present invention refers to a mount for multiple substrates to be treated in a surface treatment.

### Description of the Background Art

A whole series of different processes are known for the polishing of surface layers of workpieces, depending on the application, material and structure of the surface layer. The purpose of polishing frequently includes reducing the roughness of the surface in addition to a pure removal of material at the surfaces. This can be desired, for example, for purely aesthetic reasons, for instance to produce glossy surfaces, or it can be required due to technical demands, for example to reduce coefficients of friction, to minimize the adhesion or inclusion of foreign particles such that a required porosity of the surface is maintained, or to prevent soiling of the surface. Aerodynamics can thereby be improved, increase of efficiency and therefore reduction of kerosene consumption. In the art, as a rule, the roughness of the surface of a solid is characterized by different roughness measuring parameters which can be found in the corresponding technical literature.

One of these roughness measuring parameters is the so-called “average roughness value Ra” which, as the mean deviation of the absolute amounts of the roughness profile from a central line within a pre-settable measuring path, is a measure for the roughness of a surface and which is given, in dependence on the degree of the roughness, in micrometers (μm) for example.

As already mentioned, different methods are used, depending on the application, for the reduction of the roughness of a surface. For instance, turbine vanes for airplane turbines or for land-based gas turbines for the generation of electrical energy are provided, for example, with layers of metallic alloys, in particular with MCrAlY layers, with M standing for a metal such as nickel (Ni), cobalt (Co) or iron (Fe) and CrAlY (chromium, aluminum, yttrium) designating a super alloy very familiar for this and other purposes. These layers can, for example, be applied in a vacuum chamber in a thickness between 50 μm and 250 μm, with a surface roughness R a typically being achieved of approximately 6 μm-12 μm. Furthermore, it is frequently necessary to provide the aforesaid MCrAlY layers with a heat insulating layer which the person skilled in the art also frequently calls a TBC coating (thermal barrier coating). Such TBC coatings can be manufactured, for example, on a zirconia (ZrO 2) basis, with—in a typical example—the heat insulating layer being able to be approximately 100 μm up to 500 μm thick, in special cases more than 1 mm and substantially including 92% ZrO 2 and 8% yttrium oxide Y 2 O 3 for stabilization. The grain sizes of the grains making up the layer can lie, for example, between 45 μm and 125 μm, with a porosity of the heat insulating layer being typically reached at between 5% and 20%. Typical values for the roughness of TBC coatings are found in the range from 9 μm up to 16 μm. It should be pointed out at this point that the aforesaid parameters of the layers, as well as their chemical composition, can differ considerably from the previously cited examples in a specific case.

In general, however other coatings such as for example TiAlN or AlTiN may be used as an alternative.

The surface roughnesses which the layers show after the application to the workpiece are, however, frequently not acceptable and must be reduced, for example, by polishing. In the example important for practice of turbine vanes for land-based turbines, values are required for the surface roughness Ra of max. 0.3 μm for Aerospace applications and Ra max. 0.8 for turbines for power generation

With MCrAlY layers, or generally with metallic or metal alloy surfaces, the required surface roughness can be achieved using different methods, with—analogous to classical sandblasting—abrasive blasting techniques, for example with fine corundum, shot peening or cut-wire peening with hard steel bodies, with rust-free steel bodies or with ceramic blasting bodies, being customary.

To achieve the highest possible surface qualities, i.e. minimum roughness and/or uniform roughness of material surfaces, various methods are available for vibropolishing in combination with polishing elements with an abrasive action.

However, only the last-mentioned methods of vibropolishing are used for the polishing of most TBC layers, since they treat the surfaces sufficiently gently in the polishing process such that damage in the form of micro-tears, peeling of surface regions or similar damage in the porous TBC coatings can be avoided.

Two variants of polishing apparatuses are widely used for the carrying out of the vibropolishing, namely so-called round vibrators and tray vibrators.

A tray vibrator is an apparatus which substantially includes a polishing container, which includes corresponding polishing elements and which can be set into vibration by suitable devices. The workpieces to be treated are, in the simplest case, placed into the polishing container such that the workpieces are polished by the polishing elements which behave overall under vibration in an analogous manner to a viscid liquid.

Partitioning slides can be provided which prevent adjacent workpieces from touching or damaging one another in the polishing container and an external attaching of the workpieces can also be provided. A masking of specific surface regions of the workpiece with covers, can also provide a further protection such that only a partial smoothing of the workpiece is allowed and/or, for example, endangered edges are protected.

These apparatuses known from the prior art have disadvantages which result in unsatisfactory results in particular in the polishing of rotationally asymmetrical workpieces and/or of workpieces having porous surfaces such as turbine vanes with TBC coatings.

For instance, unacceptably high mechanical strains can act on externally clamped workpieces treated in a tray vibrator which, in the worst case, can result in damage to the workpiece and/or to the surfaces to be treated, in particular to porous and/or brittle surfaces. If the workpieces to be polished are placed directly into the polishing container of the tray vibrator in accordance with the prior art, that is, without an external fastening, the risk exists that the workpiece can come into direct contact with the walls of the tray vibrator or with any possibly present partitioning slides and/or with adjacent workpieces, whereby damage to the workpiece or to sensitive regions of the surface of the workpiece, in particular at edges, cannot be precluded. The risk in particular exists that, for example, a distance of less than two polishing elements is adopted between the workpiece surface and an adjacent bounding wall such that a polishing element is jammed between the workpiece surface and an adjacent bounding wall, which can result in enormous point strains on the surface of the workpiece.

Damage of the previously described kind can be reduced by suitable masking of endangered surface regions. However, this is only possible for those surface regions which do not have to be polished. In addition, this method is very complex in practice since frequently more than one surface region has to be protected separately in each case by a suitable masking, which is associated with a complex installation or removal of the corresponding parts and is thus less efficient from an economic viewpoint. A further substantial disadvantage is the fact that, in particular with rotationally asymmetrical workpieces such as turbine vanes for land-based applications or for airplane turbine engines, the known methods result in insufficient surface roughnesses and/or in particular in non-uniformly polished regions, i.e. regions with non-uniform roughness on the surface of the workpiece. Due to the asymmetrical mass distribution, for example of a turbine vane, the turbine vane will only rotate non-uniformly between the polishing elements in the polishing container and the differently oriented surfaces of the turbine vane are acted upon by the polishing elements with different polishing pressures during polishing, which ultimately results in different regions of the surface having different surface roughnesses, and in a sufficiently high roughness not being reached at all at certain surfaces of the turbine vane. What was said above is also true in another respect for polishing methods in which the workpiece is externally fastened. The previously described disadvantages do not only occur on the polishing of turbine vanes, for which the problems are explained here by way of example, but also occur generally in vibropolishing, in particular with rotationally asymmetrical workpieces.

In order to at least partially overcome these disadvantages, U.S. Pat. No. 6,817,051, which is incorporated herein by reference, to Tanner discloses a vibropolishing apparatus for a workpiece which has a porous surface coating comprising a polishing container and a guide apparatus disposed in the container for guiding and holding the workpiece in the polishing container, the guide apparatus having first and second guide members which are spaced apart by at least one spacer and a holder for positioning and holding the workpiece between the guide members, the guide apparatus being formed and disposed in the polishing container so that it is freely movable, freely rotatable and can take any position relative to the polishing container while preventing the workpiece from contacting the polishing container during polishing. This is an excellent solution to realize smooth surfaces for turbine vanes without damaging the edges.

However, there are two main issues in the conventional art for polishing turbine vanes, namely: (1) in general, many of these turbine vanes need to be polished. In order to fix the vanes into the guides there is a lot of manual handling involved. This takes time and makes the whole process economically uninteresting; and (2) the fact that the guide apparatus is formed and disposed in a manner so that it is freely movable, freely rotatable and can take any position relative to the polishing container renders the polishing process inefficient as the vibrations are transferred to the vanes in an indirect manner only.

### SUMMARY OF THE INVENTION

It is therefore an object of the present invention to provide a surface treatment apparatus and in particular to a surface polishing apparatus that at least overcomes the issues as mentioned above.

The invention may follow a number of principles: using a fixture which is directly connected to the container, thereby transferring the vibrations of the container directly to the fixture; using a fixture in which multiple substrates can be placed in such a manner that they come to lay in planes and that they are radially oriented, one end oriented to the center of a circle, another end radially extending away from the center, all substrates having the same distance to the center, constituting a fixture ring; and forming fixture rings in such a manner, that a number of them can be stacked to layered fixture rings, all fixture rings of the stack having the center on one axis, forming the center axis. The stack of fixture rings resulting in a cylindrical stack.

The fixture rings can be formed by segments which can be disassembled.

An outer surface of the cylindrical stack can be closed thereby masking the outer ends of the substrates to be polished.

The inner ends of the substrates to be polished can be covered by an inner ring as provided by the fixture rings.

The outer segment can comprise lower sockets basings formed by spacer sections and/or the cap segment comprises upper sockets basings formed by spacer sections to hold and shield the basis of turbine vanes mounted in between.

The inner segment or ring carries radial extensions may be formed to abut the tips of turbine vanes for protection. Preferably, the radial extensions have a base section connecting the extension to the inner ring at a tip section, formed to match the shape and curvature of the tips of the turbine vanes mounted in the segment like an extension of a turbine blade.

The segment can comprises an outside segment arranged radially outward of the outer segment wherein the outer segment is profiled in such a manner that the basis turbine vanes can be placed on it with vanes extending radially outward and radially inward. The inner segment is realized in a manner to shield the tips of the turbine vanes extending inward and the outside segment is realized in a matter to shield the tips of turbine vanes extending outward. Optionally, either the outside segment or the inside segment or both carries radial extensions formed to abut the tips of turbine vanes for protection.

The segments can be made of thermoplastic polyurethane (TPU) material and/or derivatives.

The cylindrical stack can comprise a bottom ring, at least one fixture ring and a closing ring. The bottom ring can comprise at least two axles which vertically extend parallel to the central axis and which may be used to fix bottom ring and the closing ring together, thereby firmly sandwiching the at least one circular ring. In case the at least one circular ring is composed of separatable segments, it is preferred to have at least two axles per segment, which penetrate through corresponding holes in the segments and thereby holding them in place to the ring.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a fixture ring according to the present invention;

FIG. 2 shows a disassembled segment where several segments put together form a fixture ring according to the present invention;

FIG. 3 shows a disassembled segment, similar to that shown in FIG. 2, according to an example of the present invention;

FIG. 4 shows a top view of an assembled segment according to FIG. 3

FIG. 5 shows a disassembled segment according to an example, similar to those shown in FIGS. 2 to 5;

FIG. 6 shows an assembled and disassembled arrangement of a turbine vane with a mounting shoe arrangement to be arranged in a fixture ring according to FIG. 2, FIG. 3 or FIG. 6;

FIG. 7 shows a disassembled segment arrangement according to an example of the present invention; and

FIG. 8 shows a cut through an assembled cylindrical stack according to the present invention

### DETAILED DESCRIPTION

Turbine vanes have a base body, with a blade on top. The end of this blade most distant to the base body is typically called the tip of the blade.

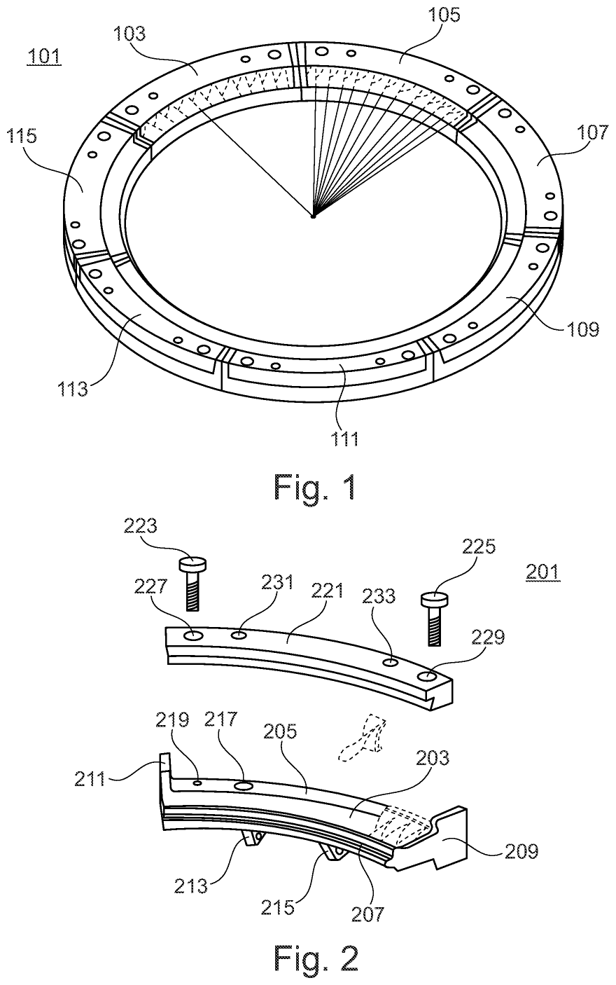

FIG. 1 shows a fixture ring 101 according to the present invention, built by seven segments 103, 105, 107, 109, 111, 113, 115. In these segments placed are turbine vanes (shown with broken lines) which are oriented in such a way, that the base body is most distant to the center of the ring and the blade tips are closest to the center of the ring. The base bodies are masked by the outer ring of the fixture ring and the tip blades are covered by an inner ring. The rest of the blades are freely accessible from above as well as from below. FIG. 1 shows the fixture ring only partially loaded with turbine vanes, in particular only segments 103 and 105 are loaded. The figure shows as well some guiding lines from the center of the ring to some of the turbine vanes, illustrating the radial orientation of the turbine vanes.

FIG. 2 shows a disassembled segment 201 with a carrier segment 203 and a cap segment 221. There are three turbine vanes loaded into the carrier segment, shown in broken lines. A fourth turbine vane is shown as well in broken lines to be loaded into the carrier segment 203.

The carrier segment 203 comprises an outer segment 205 and an inner segment 207 which when segments are assembled to a fixture ring form an outer ring and a inner ring. Outer segment 205 and inner segment 207 are fixed together by segment end plates 209 and 211. In order to increase the stability of carrier segment 203 two connection arms 213 and 215 are used to additionally stabilize outer segment 205 and inner segment 207. The carrier segment 203 in addition comprises at least two holes 217 (in the FIG. 2 the second hole 217 cannot be seen as it is behind the turbine vanes already loaded onto the carrier segment). These holes may be used to allow axles of the bottom ring to penetrate through the segment 201 in order to correctly place the segment by kind of impaling it. The carrier segment in addition comprises at least two thread holes 219 (in the FIG. 2 the second thread hole 219 cannot be seen as it is behind the turbine vanes already loaded onto the carrier segment). These thread holes are used to fix the cap segment 221 onto the carrier segment 203 with the help of screws 223 and 225.

The outer ring 205 of the carrier segment 203 is formed in such a way, that turbine vanes can be placed on it. The profile may for example be a step profile in order to place the base body of the turbine vane on it. In other words, the profile of the outer ring 205 is adapted to the shape of the base body of the turbine vane.

The inner ring 207 of the carrier segment 203 has mainly the function of shielding the blade tip. This may be an unstructured surface which the tips of the blades just touch when loaded onto the carrier segment 203.

The cap segment 221 when fixed to the carrier segment 203 has the task to firmly fix the turbine vanes loaded into the carrier segment 203. Therefore, the profile of the cap segment 221 is as well adapted to the shape of the base body of the turbine vane. In order to attach the cap segment 221 to the carrier segment 203 loaded with the turbine vanes, the cap segment 221 comprises holes 227 and 229 corresponding to the thread hole 219 of the carrier segment 203.

The cap segment 221 in addition comprises at least two holes 231 and 233. These holes may be used to allow axles of the bottom ring to penetrate through the segment 201 in order to correctly place the segment by kind of impaling it.

Once the carrier segment 203 is loaded with turbine vanes and the cap segment 221 is attached to the carrier segment, the turbine vane bodies are clamped in between carrier segment 203 and cap segment 221 and therefore firmly fix and as well completely masked. In addition, the blade tips are masked by the inner ring 207 of the carrier segment 203. However the blades of the turbine vanes are fully accessible from the top as well as from the bottom and for example polishing material may reach the respective surfaces without any obstacle.

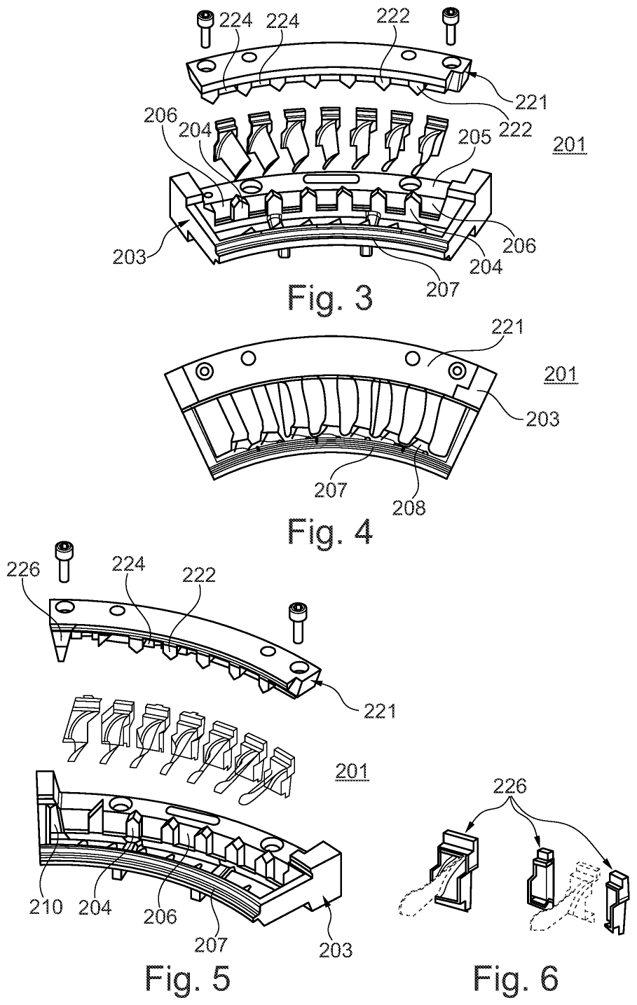

FIGS. 3 and 4 show a second embodiment according to the present invention. Apart from the components and features already described in connection with FIG. 2, this segment 201 comprises also a carrier segment 203 and a cap segment 221, both having several spacer sections 204, 222. At the carrier segment 203 they form lower socket areas 206 at the outer segment 205.

The cap segment 221 comprises spacer sections 222 to form upper socket areas 224. The lower socket area 206 and the upper socket area 224 form a two-part socket to wrap the foot of the turbine blades when the carrier segment 203 and the cap segment 221 are assembled with the turbine blades mounted in between.

Further, the inner segment or inner ring 207 of the carrier segment 203 carries protection extensions 208 which extend radially in direction to the mounted turbine blades and preferably match the shape and curvature of the blade like an extension which becomes broader in an inward direction towards the inner ring.

In an example (FIG. 5) of the segment 201, an even more protective and supporting holding arrangement of the turbine blades can be realized. In addition to the spacer sections 204 and 222 which form the lower and upper socket areas 206 and 224, a lower and an upper notch 210 and 226 can be formed to squeeze the foot of the blade into the lower and the upper socket spacing 206 and 224 when the carrier segment 203 and the cap segment 221 are mounted and fixed to each other.

In addition to these socket areas 206 and 224, additional thin walled shells 226 can be provided which protect the foot of the blades like an additional protective sock (FIG. 6). These two shells 226 are very thin and match the shape of the foot of the blade. They are preferably made of an elastic but strong material such as TPU or similar to allow for an elastic but very robust fixation of the turbine blades between the carrier segment 203 and the cap segment 221.

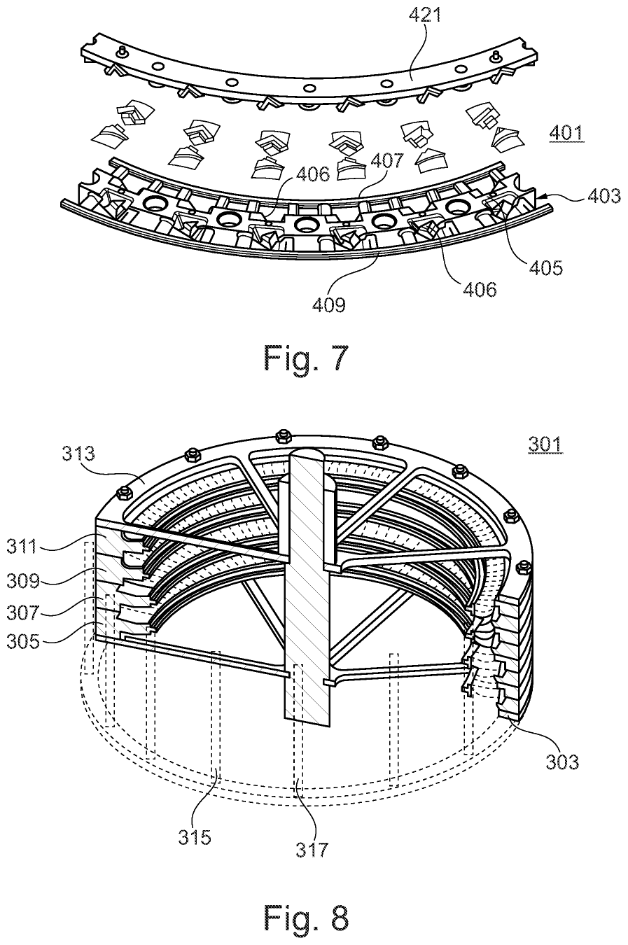

FIG. 7 shows an example of a segment 401 which allow for a double circle arrangement of blades within a carrier 403. The carrier segment 03 comprises an outer segment forming a central mounting ring 05 with lower socket areas 406, an inner segment ring 407 to protect the tips of the mounted blades extending radially inward, and an outside segment forming an outer segment ring 409 to protect the tips of the mounted blades extending radially outwards. A cap segment 421 can be fixed to the segment 403 by screws.

To allow for a strong but elastic containment of the turbine blades during polishing, the segments may be manufactured from a strong but still elastic material such as thermoplastic polyurethane (TPU) material and derivatives.

FIG. 8 shows a cut through an assembled cylindrical stack 301 according to the present invention. The cylindrical stack 301 comprises a bottom ring 303, a first, second third and fourth fixture ring 305, 307, 309 and 311 as well as a closing ring 313.

In addition to the cut, the bottom ring 303 is completed with broken lines. This allows to show axels, such as for example 315 and 317 which allow to load the bottom ring 303 with segments and to align them to fixture rings.

The closing ring 313 is then put on top of the stack of bottom ring and fixture rings and fixed with screws. In the center of the stack a central axle is provided to which bottom ring as well as closing ring are connected via arms.

The whole stack may then be fixed to a vibration container and the setup may be used as tray system and/or rotatory system.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A segment of a fixture comprising a plurality of segments arranged to form a fixture ring, the segment comprising a carrier segment and a cap segment.

2. The segment of claim 1, wherein the carrier segment comprises an outer segment and an inner segment which when segments are assembled to a fixture ring form an outer ring and an inner ring.

3. The segment according to claim 2, wherein the outer segment is profiled in such a manner that the basis turbine vanes are adapted to be placed on the outer segment and the inner segment shields tips of turbine vanes.

4. The segment according to claim 3, wherein the outer segment comprises lower socket spacings formed by spacer sections and/or the cap segment comprises upper socket spacings formed by spacer sections formed to hold and shield the basis of turbine vanes.

5. The segment according to claim 3, wherein the inner segment carries radial extensions formed to abut the tips of the turbine vanes for protection.

6. The segment according to claim 5, wherein the radial extensions have base section connecting the extension to the inner ring and a tip section, formed to match the shape and the curvature of the tips of the turbine vanes mounted in the segment like an extension of a turbine blade.

7. The segment according to claim 3, further comprising an outside segment arranged radially outward of the outer segment, wherein the outer segment is profiled in such a manner that the basis turbine vanes are adapted to be placed on the outer segment with vanes extending radially outward and radially inward, wherein the inner segment is realized in a manner to shield the tips of turbine vanes extending inward and the outside segment is realized in a manner to shield the tips of turbine vanes extending outward.

8. The segment according to claim 1, wherein the segment is made of a thermoplastic polyurethane (TPU) material or a derivative thereof.

9. A fixture ring formed by at least two segments according to claim 1, wherein two or more rings are stackable and releasably fixed to each other.

10. A cylindrical stack of fixture rings according to claim 9.
